(19) United States
(12) Patent Application Publication
(10) Pub. No.: US 2026/0147302 A1
(43) Pub. Date: May 28, 2026

(54) IMAGE FORMING APPARATUS, IMAGE FORMING SYSTEM, AND NON TRANSITORY STORAGE MEDIUM

(71) Applicant: Nobuaki Takahashi, Sunto Shizuoka (JP)

(72) Inventor: Nobuaki Takahashi, Sunto Shizuoka (JP)

(73) Assignee: ETRIA Co., Ltd., Kanagawa (JP)

(21) Appl. No.: 19/397,594

(22) Filed: Nov. 21, 2025

(30) Foreign Application Priority Data
Nov. 25, 2024 (JP) 2024-204643

(51) Int. Cl. G03G 15/00; G01G 19/414; G03G 15/08; G03G 21/16; G03G 21/20; H04N 1/00

(52) U.S. Cl. CPC G03G 15/55; G01G 19/414; G03G 15/0898; G03G 15/5079; G03G 21/1647; G03G 21/206; H04N 1/00037; H04N 1/00244; H04N 2201/0094

(57) ABSTRACT

According to embodiments, an image forming apparatus includes an image forming station, a filter, a sensor, and a processor. The image forming station performs image formation using a toner. The filter collects the toner scattering from the image forming station. The sensor detects the weight of the filter including the toner collected by the filter. In a case where the weight detected by the sensor exceeds a predetermined threshold before a predetermined maintenance period comes, the processor detects information representing the abnormality of a toner collection amount in the filter.

### CROSS REFERENCE TO RELATED APPLICATIONS

This application is based upon and claims the benefit of priority from Japanese Patent Application No. 2024-204643, filed Nov. 25, 2024, the entire contents of which are incorporated herein by reference.

### FIELD

Embodiments of the present invention relate to an image forming apparatus, an image forming system, and a non-transitory storage medium.

### BACKGROUND

An image forming apparatus installed in a workplace forms on paper a visible image corresponding to image data. A conventional image forming apparatus includes a mechanism that generates a flow of air by a fan motor and collects a foreign substance by a filter provided on an airflow path. An electrophotographic image forming apparatus includes a mechanism that recovers a toner scattering outside a developing unit together with air, a mechanism that supplies outer air to a specific portion, a mechanism that sucks air from a specific portion, and the like.

The electrophotographic image forming apparatus forms a visible image (toner image) by applying a toner to an electrostatic latent image formed by light irradiating a charged photosensitive drum. Some electrophotographic image forming apparatuses include a toner suction unit for recovering a toner scattering between the developing unit and the photosensitive drum. The toner suction unit includes a fan motor, and a toner filter that collects a toner contained in air sucked by the fan motor. In a conventional image forming apparatus, the toner filter is replaced in periodic maintenance executed in accordance with the printing amount or the like.

However, when the toner suction unit sucks a larger-than-expected amount of toner, the toner filter may clog before periodic maintenance. Upon clogging of the toner filter, the toner is hardly sucked by the toner suction unit and is highly likely to scatter within the body. The toner scattering in the body hinders cleaning and causes a malfunction of each unit. To solve this problem, the image forming apparatus needs to detect a filter state such as clogging.

### BRIEF DESCRIPTION OF THE DRAWINGS

FIG. 1 is a schematic view of the configuration of a printing system including an image forming apparatus according to an embodiment.

FIG. 2 is a sectional view schematically showing a configuration example of the image forming apparatus according to the embodiment.

FIG. 3 is a block diagram showing a configuration example of a control system in the image forming apparatus according to the embodiment.

FIG. 4 is a sectional view showing a configuration example of an electrophotographic image forming station in the image forming apparatus according to the embodiment.

FIG. 5 is an outside view showing a configuration example of a toner suction unit in the image forming apparatus according to the embodiment.

FIG. 6 is a sectional view showing a configuration example of the inside of the toner suction unit in the image forming apparatus according to the embodiment.

FIG. 7 is a view showing a configuration example of a connection path between the toner suction unit and a recovery unit in the developing unit of each image forming station in the image forming apparatus according to the embodiment.

FIG. 8 is a view showing a configuration example of the connection path between the toner suction unit and the recovery unit in the developing unit of each image forming station in the image forming apparatus according to the embodiment.

FIG. 9 is a view showing an example of a factor that increases the amount of toner scattering from the developing unit to be more than an expected amount in the image forming apparatus according to the embodiment.

FIG. 10 is a view showing the first configuration example of a weight detector that detects the weight of a toner collected by the toner filter in the image forming apparatus according to the embodiment.

FIG. 11 is a view showing the second configuration example of the weight detector that detects the weight of a toner collected by the toner filter in the image forming apparatus according to the embodiment.

FIG. 12 is a flowchart for explaining state detection processing of detecting the state of the toner filter using the weight detector of a first or second configuration example by the image forming apparatus according to the embodiment.

FIG. 13 is a view showing the third configuration example of the weight detector that detects the weight of a toner collected by the toner filter in the image forming apparatus according to the embodiment.

FIG. 14 is a flowchart for explaining state detection processing of detecting the state of the toner filter using a detector as the weight detector of a third configuration example by the image forming apparatus according to the embodiment.

### DETAILED DESCRIPTION

According to embodiments, an image forming apparatus includes an image forming station, a filter, a sensor, and a processor. The image forming station performs image formation using a toner. The filter collects the toner scattering from the image forming station. The sensor detects the weight of the filter including the toner collected by the filter. In a case where the weight detected by the sensor exceeds a predetermined threshold before a predetermined maintenance period comes, the processor detects information representing the abnormality of a toner collection amount in the filter.

An image forming apparatus according to an embodiment will be described below with reference to the accompanying drawings.

Note that the scale of each unit is appropriately changed in each drawing used in the description of the following embodiment. For the sake of explanation, a configuration is properly omitted in each drawing used in the description of the following embodiment.

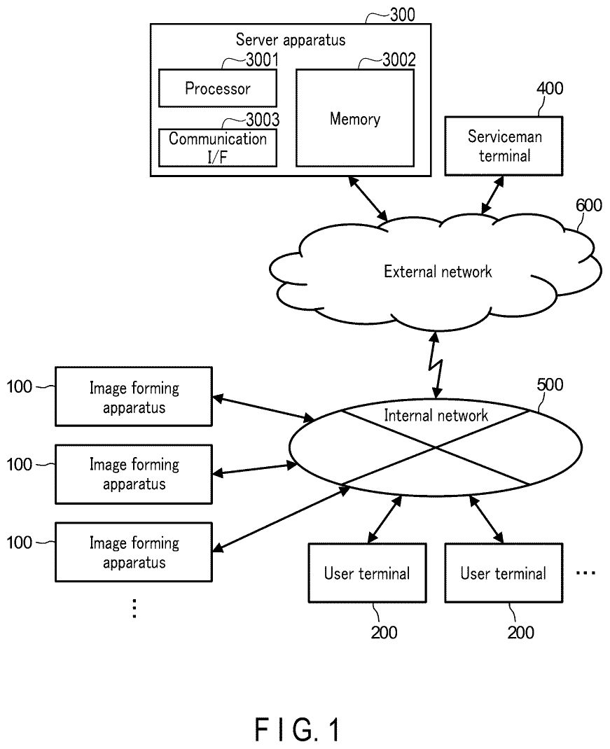

FIG. 1 is a schematic view of the configuration of a printing system (image forming system) including a plurality of image forming apparatuses 100 according to the embodiment. The printing system including the image forming apparatuses 100 further includes a plurality of user terminals 200, a server apparatus 300, and a serviceman terminal 400.

Each image forming apparatus 100 is installed in a workplace, and communicably connected to the user terminal 200 arranged in, for example, the same workplace via an internal network 500 such as a LAN (Local Area Network). This connection may be a wired connection or a wireless connection. The internal network 500 is connected to an external network 600 such as the Internet. The server apparatus 300 and the serviceman terminal 400 are connected to the external network 600. The image forming apparatus 100 is communicably connected to the server apparatus 300 via the internal network 500 and the external network 600.

The user terminal 200 is an information processing apparatus that designates printing by any image forming apparatus 100. The user terminal 200 is an information processing apparatus such as a personal computer (PC), a smartphone, a tablet terminal, or a digital camera. Note that the user terminal 200 may be communicably connected to the image forming apparatus 100 via the external network 600 and the internal network 500. That is, the user terminal 200 may be arranged outside the workplace where the image forming apparatus 100 is installed. The user terminal 200 may be directly connected to the image forming apparatus 100 without the intervention of the external network 600 and the internal network 500. That is, the user terminal 200 may be locally connected to the image forming apparatus 100. Even when the user terminal 200 is locally connected to the image forming apparatus 100, the connection may be a wired connection or a wireless connection.

The server apparatus 300 is a computer apparatus that is operated directly by a management company that undertakes maintenance and inspection of the image forming apparatus 100, or by a service provider under contract. The server apparatus 300 obtains maintenance information of each image forming apparatus 100 periodically or as needed. The maintenance information includes information representing the operation state (print count, the size and type of printed paper, and the like) of the image forming apparatus 100, information representing the state of each unit (information representing the state of the filter), and the like. The server apparatus 300 may obtain notification data such as an alert transmitted from the image forming apparatus 100.

Based on the obtained data, the server apparatus 300 determines the necessity of inspection or repair (maintenance) of each image forming apparatus 100. When there is the image forming apparatus 100 requiring maintenance, the server apparatus 300 transmits, to the serviceman terminal 400, information that specifies the image forming apparatus 100 requiring maintenance. In response to this, the serviceman can perform maintenance of the image forming apparatus 100 determined by the server apparatus 300 to require maintenance.

The server apparatus 300 is an information processing apparatus including a processor 3001, a memory 3002, and a communication interface (I/F) 3003. The processor 3001 is, for example, a CPU. The processor 3001 executes various processes by executing programs stored in the memory 3002. The communication interface 3003 is an interface for communicating with each apparatus via the network 600. The memory 3002 is constituted by storage devices such as a ROM, a RAM, and a nonvolatile memory. The memory 3002 includes a program memory that stores programs, a working memory that temporarily holds data, and a data memory in which data are accumulated.

In the server apparatus 300, the memory 3002 has a storage area where a database configured to store maintenance information and the like obtained from the image forming apparatus 100 is stored. The processor 3001 of the server apparatus 300 stores, in the database of the memory 3002, information such as maintenance information obtained from the image forming apparatus 100. The processor 3001 of the server apparatus 300 determines the necessity of maintenance of each image forming apparatus based on maintenance information of the image forming apparatus stored in the database.

The serviceman terminal 400 is an information processing apparatus such as a smartphone or a tablet terminal carried by a serviceman who executes maintenance of the image forming apparatus 100. Note that FIG. 1 shows only one serviceman terminal 400, but the printing system can include a plurality of serviceman terminals 400. The serviceman terminal 400 may have a position detection function, and transmit a position detected by the position detection function as position information of the serviceman to the server apparatus 300. Based on information such as position information of each serviceman and the availability of each serviceman, the server apparatus 300 can assign a proper serviceman to the image forming apparatus 100 requiring maintenance.

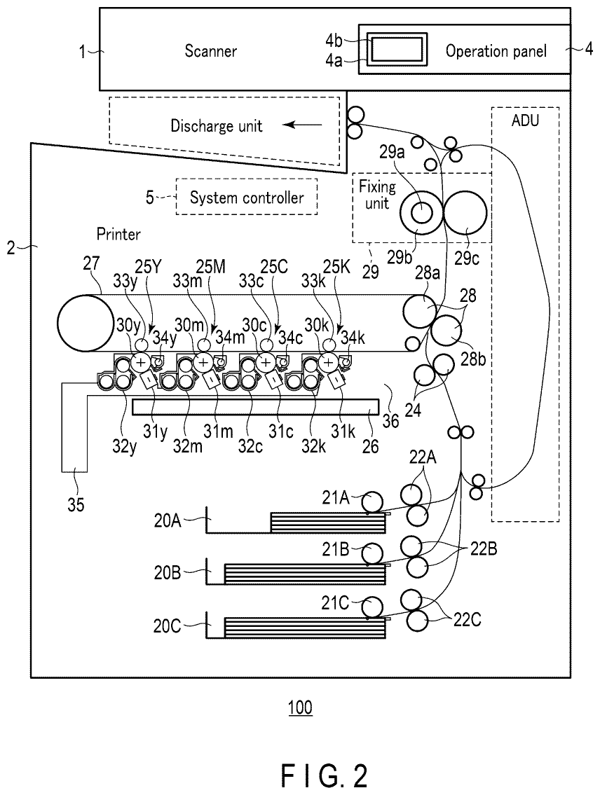

FIG. 2 is a sectional view schematically showing a configuration example of the image forming apparatus 100 according to the embodiment. The image forming apparatus 100 according to the embodiment is assumed to be a digital MFP (Multi-Functional Peripheral). In the configuration example shown in FIG. 2, the image forming apparatus 100 is a digital MFP including a scanner 1, a printer 2, an operation panel 4, and a system controller 5.

The scanner 1 is a device that reads the image of an original and converts it into image data. The scanner 1 is constituted by, for example, a CCD (Charge Coupled Device) line sensor that converts an image on the read surface of an original into image data. The scanner 1 may have a function of scanning an original on an original platen glass. Also, the scanner 1 may have a function of reading the image of an original conveyed by an ADF (Auto Document Feeder). For example, the scanner 1 is installed at the upper portion of the main body of the MFP serving as the image forming apparatus 100. The scanner 1 is controlled by the system controller 5. The scanner 1 outputs image data of an original to the system controller 5.

The printer 2 forms an image on a sheet serving as a printing medium. The printer 2 is, for example, an electrophotographic printer. The image forming method of the image forming apparatus 100 according to the embodiment is not limited to the electrophotographic method. However, in the description of the embodiment, the image forming apparatus 100 includes an electrophotographic printer 2. The printer 2 has a color printing function of printing a color image on a sheet, and a monochrome printing function of printing a monochrome (for example, black) image on a sheet. The printer 2 forms a color image using toners of a plurality of colors (for example, three, yellow (Y), cyan (C), and magenta (M) colors). Also, the printer 2 forms a monochrome image using a monochrome (for example, black (K)) toner.

In the configuration example shown in FIG. 2, the printer 2 includes paper cassettes 20 (20A, 20B, and 20C). The paper cassette 20 is a paper feed unit that supplies a sheet for printing an image. As the paper feed unit, the printer 2 may include a manual feed tray or the like. For example, the paper cassettes 20A, 20B, and 20C are detachably provided at the lower portion of the main body of the MFP. In the paper cassettes 20A, 20B, and 20C, sheets of types (for example, sizes and paper qualities) respectively set for them are stored.

The paper cassettes 20A, 20B, and 20C include pickup rollers 21A, 21B, and 21C, respectively. The pickup rollers 21A, 21B, and 21C pick up sheets one by one from the paper cassettes 20A, 20B, and 20C. The pickup rollers 21A, 21B, and 21C supply the picked-up sheets to a conveyance path (conveyance unit 22) constituted by a plurality of conveyance rollers 22A, 22B, and 22C, and the like.

The conveyance unit 22 conveys a sheet within the printer 2. For example, the conveyance unit 22 conveys a sheet picked up by the pickup roller 21A, 21B, or 21C to registration rollers 24. The registration rollers 24 convey the sheet to a transfer position at a timing to transfer an image on the sheet from a transfer belt 27. The conveyance unit 22 conveys the sheet having passed through the registration roller 24 to the transfer position. The conveyance unit 22 conveys the sheet having passed through the transfer position from the transfer position to a fixing unit 29. The conveyance unit 22 conveys the sheet having passed through the fixing unit 29 to either a discharge unit or an ADU (Automatic Double-sided Unit).

Image forming stations 25 (25Y, 25M, 25C, and 25K) form an image to be transferred to a sheet. In the configuration example shown in FIG. 2, the image forming station 25Y forms an image with the yellow toner. The image forming station 25M forms an image with the magenta toner. The image forming station 25C forms an image with the cyan toner. The image forming station 25K forms an image with the black toner.

The image forming stations 25 (25Y, 25M, 25C, and 25K) include photosensitive drums 30 (30y, 30m, 30c, and 30k), charging units 31 (31y, 31m, 31c, and 31k), developing units 32 (32y, 32m, 32c, and 32k), transfer rollers 33 (33y, 33m, 33c, and 33k), and cleaners 34 (34y, 34m, 34c, and 34k).

The photosensitive drum 30 is an image carrier on which an electrostatic latent image is formed. The photosensitive drum 30 rotates on a rotating shaft. The charging unit 31 charges the surface of the photosensitive drum 30 to a predetermined potential. The charging unit 31 includes a grid (not shown) for adjusting a charging output to the photosensitive drum 30. The developing unit 32 develops with a toner an electrostatic latent image formed on the photosensitive drum 30. The transfer roller 33 transfers to the transfer belt 27 a toner image developed on the photosensitive drum 30. The cleaner 34 cleans the surface of the photosensitive drum 30 after transfer.

Each image forming station 25 is connected to a toner suction unit 35, an ozone processing unit 36, and the like. The toner suction unit 35 recovers a toner scattering between the developing unit 32 and the photosensitive drum 30 in each image forming station 25. The ozone processing unit 36 supplies outer air into the charging unit 31 to suck an ozone-containing gas, and exhausts air outside the apparatus after decomposing ozone from the sucked gas.

An exposure unit 26 forms an electrostatic latent image on the photosensitive drum 30 of each image forming station 25 (25Y, 25M, 25C, or 25K) with a laser beam. The exposure unit 26 irradiates the photosensitive drum 30 through an optical system such as a polygon mirror with a laser beam that is controlled in accordance with image data. The laser beam from the exposure unit 26 forms an electrostatic latent image on the surface of each photosensitive drum 30. The exposure unit 26 controls the laser beam in accordance with a control signal from the system controller 5.

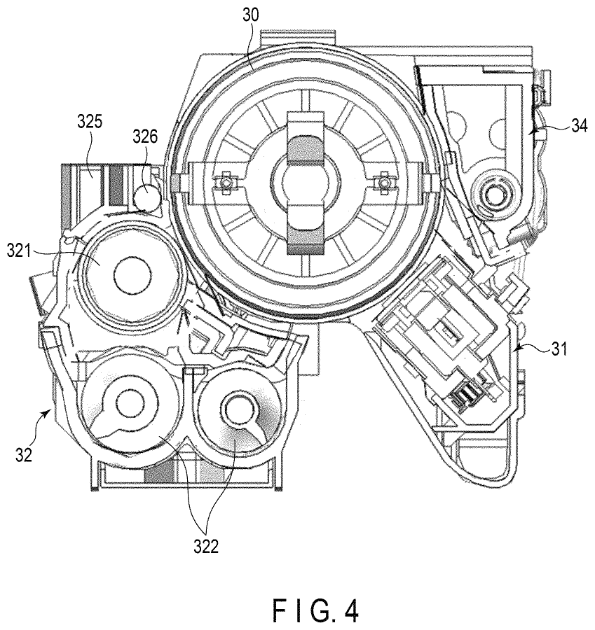

Each image forming station 25 (25Y, 25M, 25C, or 25K) develops the electrostatic latent image formed on the corresponding photosensitive drum 30 by the corresponding developing unit 32. Each developing unit 32 includes a developing container with a developing roller. The developing container contains a toner serving as a developing material of each color. The toner is stirred together with a carrier within the developing container and charged. A developing bias is applied to a developing roller 321 (see FIG. 4). The developing bias-applied developing roller rotates in a state in which the toner is attracted to the surface (outer surface), and supplies the toner on the outer surface to the electrostatic latent image on the photosensitive drum 30. The electrostatic latent image on the photosensitive drum 30 is developed as a toner image (visible image) with the supplied toner.

The developing unit 32 is coupled to the toner suction unit 35 for sucking a toner scattering between the developing unit 32 and the photosensitive drum 30. The developing unit 32 recovers the toner scattering between the developing unit 32 and the photosensitive drum 30, and delivers it to the toner suction unit 35. The toner suction unit 35 sucks the toner scattering between the developing unit 32 and the photosensitive drum 30, and collects the sucked toner by a toner filter 353 (to be described later).

The transfer belt 27 is an intermediate transfer member. Each image forming station 25 (25Y, 25M, 25C, or 25K) transfers (primarily transfers), onto the transfer belt 27, the toner image formed on the photosensitive drum 30 by applying a primary transfer voltage to the transfer belt 27 by the transfer roller 33. For example, in the image forming station 25K, the transfer roller 33k transfers, onto the transfer belt 27, a toner image developed with the black toner by the developing unit 32k. When forming a color image, the respective image forming stations 25Y, 25M, 25C, and 25K transfer, onto the transfer belt 27, toner images developed with the toners of the respective colors so as to overlap each other.

A transfer unit 28 transfers the toner image on the transfer belt 27 to a sheet at a secondary transfer position. The secondary transfer position is a position where a toner image on the transfer belt 27 is transferred to a sheet. The secondary transfer position is a position where a support roller 28a and a secondary transfer roller 28b face each other.

The fixing unit 29 fixes a toner to a sheet. The fixing unit 29 applies fixing heat to the sheet. In the example shown in FIG. 2, the fixing unit 29 is constituted by a heat roller 29b incorporating a heating unit 29a, and a pressurizing roller 29c that comes into contact with a fixing belt heated by the heat roller 29b under pressure. The heating unit 29a suffices to be a temperature controllable heater. For example, the heating unit 29a may be constituted by a heater lamp such as a halogen lamp, or an induction heating (IH) heater. The heating unit 29a may be constituted by a plurality of heaters. The fixing unit 29 conveys a sheet having undergone fixing processing to either the discharge unit or the ADU.

The operation panel 4 is a user interface. The operation panel 4 includes various buttons, and a display 4a having a touch panel 4b. The system controller 5 controls contents to be displayed on the display 4a of the operation panel 4. The display 4a displays a guide or the like. The operation panel 4 outputs, to the system controller 5, information input to the touch panel 4b or button of the display 4a. The user designates an operation mode on the operation panel 4, and inputs information such as setting information.

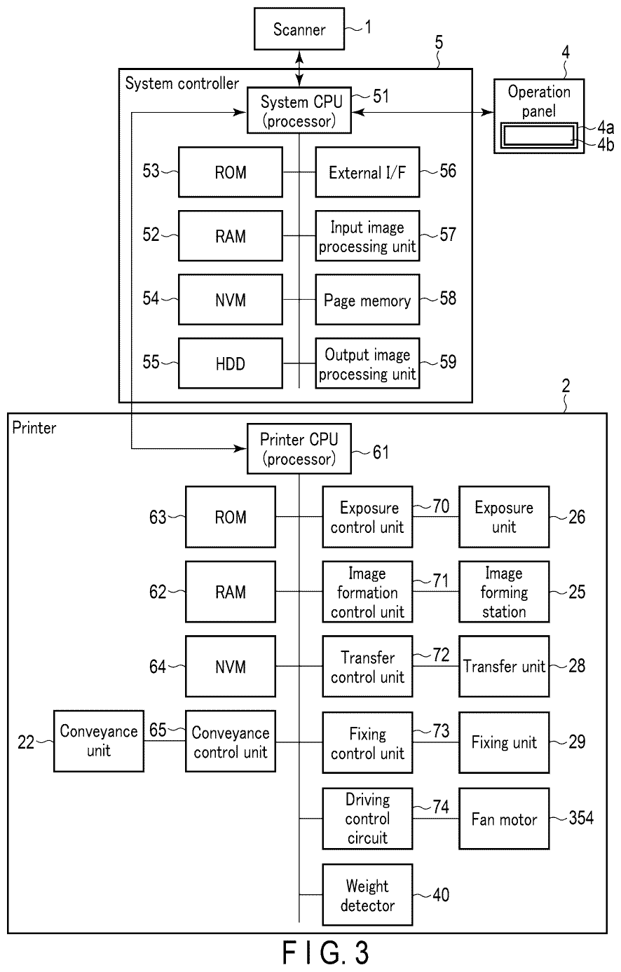

Next, the configuration of a control system in the image forming apparatus 100 according to the embodiment will be explained. FIG. 3 is a block diagram schematically showing a configuration example of the control systems of the system controller 5 and printer 2 in the image forming apparatus 100 according to the embodiment.

In the configuration example shown in FIG. 3, the system controller 5 includes a system CPU (Central Processing Unit) 51 serving as a processor, a RAM (Random Access Memory) 52, a ROM (Read Only Memory) 53, a non-volatile memory (to be referred to as a NVM in FIG. 3) 54, an HDD (Hard Disk Drive) 55, an external interface (to be referred to as an I/F in FIG. 3) 56, an input image processing unit 57, a page memory 58, and an output image processing unit 59.

The system CPU 51 is a control unit that comprehensively controls the respective units of the image forming apparatus 100. The system CPU 51 is a processor that implements processing by executing a program. The system CPU 51 is connected to each unit within the system controller 5 via a system bus. The system CPU 51 is also connected to the scanner 1, the printer 2, the operation panel 4, and the like via the system bus. The system CPU 51 outputs an operation instruction to each unit and obtains various kinds of information from each unit by bidirectional communication with the scanner 1, the printer 2, and the operation panel 4.

For example, when the image forming apparatus 100 is powered, the system CPU 51 operates by executing a program stored in the ROM 53 (or the non-volatile memory 54). In response to reception of a print job from the user terminal 200, the system CPU 51 instructs the printer 2 to perform printing represented by the print job. When copying is designated on the touch panel 4b of the operation panel 4, the system CPU 51 performs copying control to print, by the printer 2, the image of an original scanned by the scanner 1.

Note that the CPU serving as a processor that constitutes the control unit may be of a multicore/multithread type, and can parallelly execute a plurality of processes. The processor is not limited to the CPU and may be a MPU (Micro Processing Unit). Further, the processor may be implemented by various other forms including integrated circuits such as an ASIC (Application Specific Integrated Circuit), a GPU (Graphics Processing Unit), a FPGA (Field-Programmable Gate Array), a DSP (Digital Signal Processor), a SoC (System on Chip), and a PLD (Programmable Logic Device). The processor may be a combination of some of them.

The RAM 52 is constituted by a volatile memory. The RAM 52 functions as a working memory or a buffer memory. The ROM 53 is a non-rewritable non-volatile memory that stores programs, control data, and the like. The system CPU 51 implements various processes by executing programs stored in the ROM 53 (or the non-volatile memory 54 or the HDD 55) while using the RAM 52. For example, the system CPU 51 executes programs to implement a function of designating execution of printing and a function of inhibiting printing.

The non-volatile memory 54 is a rewritable non-volatile memory. The non-volatile memory 54 stores control programs that are executed by the system CPU 51, and control data. Also, the non-volatile memory 54 stores various kinds of setting information, processing conditions, and the like. For example, the non-volatile memory 54 stores setting information for each paper cassette (paper feed unit).

The HDD 55 is a large-capacity storage device. The HDD 55 stores image data, various kinds of operation history information, and the like. The HDD 55 may store control programs, control data, and the like. The HDD 55 may store setting information, processing conditions, and the like.

The external interface 56 is an interface for communicating with an external apparatus. For example, the external interface 56 receives a print job from the user terminal 200 serving as an external apparatus, and transmits data to the server apparatus 300 serving as an external apparatus. The external interface 56 suffices to be an interface that performs data communication with an external apparatus.

The input image processing unit 57 performs image processing on image data scanned by the scanner 1. The input image processing unit 57 has functions such as shading correction processing, tone conversion processing, inter-line correction processing, and compression/decompression processing. The input image processing unit 57 stores image data having undergone image processing in the page memory 58.

The page memory 58 is a memory for expanding image data. For example, the page memory 58 stores image data obtained by performing image processing by the input image processing unit 57 on image data scanned by the scanner 1. The page memory 58 may store image data contained in a print job obtained via the external interface 56.

The output image processing unit 59 generates printing image data to be printed on a sheet by the printer 2. The output image processing unit 59 performs image processing to convert image data stored in the page memory 58 into printing image data. The output image processing unit 59 transmits the data having undergone the image processing to the printer 2.

Next, a configuration example of a control system in the printer 2 will be explained.

In the configuration example shown in FIG. 3, the printer 2 includes, as building components of the control system, a printer CPU 61, a RAM 62, a ROM 63, a non-volatile memory (NVM) 64, a conveyance control unit 65, an exposure control unit 70, an image formation control unit 71, a transfer control unit 72, a fixing control unit 73, a driving control circuit 74, a driving control circuit 75, a driving control circuit 76, and the like.

The printer CPU 61 controls the overall printer 2. The printer CPU 61 is a processor that implements processing by executing a program. Note that the processor is not limited to the CPU, and may be implemented by various other forms including integrated circuits such as a MPU, an ASIC, a GPU, a FPGA, a DSP, a SoC, and a PLD. The processor may be a combination of some of them.

The printer CPU 61 is connected to each unit within the printer 2 via a system bus. The printer CPU 61 outputs an operation instruction to each unit within the printer 2 in accordance with an operation instruction from the system CPU 51. The printer CPU 61 notifies the system CPU 51 of information representing a processing status in the printer 2.

The RAM 62 is constituted by a volatile memory. The RAM 62 functions as a working memory or a buffer memory. The ROM 63 is a non-rewritable non-volatile memory that stores programs, control data, and the like. The printer CPU 61 implements various processes by executing programs stored in the ROM 63 (or the non-volatile memory 64) while using the RAM 62.

The non-volatile memory 64 is a rewritable non-volatile memory. For example, the non-volatile memory 64 stores control programs that are executed by the printer CPU 61, control data, and history data generated by executing a control program by the printer CPU 61. In addition, the non-volatile memory 64 may store setting information, processing conditions, and the like.

The conveyance control unit 65 controls conveyance of a sheet within the printer 2. The conveyance control unit 65 controls driving of the pickup rollers 21, the conveyance rollers 22A, 22B, and 22C of the conveyance unit 22, and the like. The conveyance control unit 65 controls driving of the conveyance rollers 22A, 22B, and 22C serving as the conveyance unit 22 in the printer 2 in accordance with an operation instruction from the printer CPU 61. For example, the printer CPU 61 instructs the conveyance control unit 65 to control conveyance of a sheet in accordance with a printing start instruction from the system controller 5.

The exposure control unit 70 controls the exposure unit 26. The exposure control unit 70 controls the exposure unit 26 to form an electrostatic latent image on the photosensitive drum 30 (30y, 30m, 30c, or 30k) of each image forming station 25 (25Y, 25M, 25C, or 25K) in accordance with an operation instruction from the printer CPU 61. For example, the exposure control unit 70 controls a laser beam that irradiates each photosensitive drum 30 from the exposure unit 26 in accordance with image data, execution of printing of which is designated by the printer CPU 61. For example, the exposure control unit 70 controls scanning with a laser beam emitted from each laser unit based on a BD signal obtained from the exposure unit 26.

The image formation control unit 71 controls driving of each image forming station 25 (25Y, 25M, 25C, or 25K). For example, the image formation control unit 71 controls the charging unit 31 to charge the surface of the photosensitive drum 30 to a predetermined potential. The image formation control unit 71 controls the developing unit 32 to develop, into a toner image of each color, the electrostatic latent image formed on the photosensitive drum 30 after charging processing. The image formation control unit 71 controls the concentration of the developing toner by controlling the developing bias or the like with respect to the developing unit 32. The image formation control unit 71 controls the transfer roller 33 to transfer, to the transfer belt 27, the toner image developed on the photosensitive drum 30. The image formation control unit 71 controls the cleaner 34 to clean the surface of the photosensitive drum 30 after transfer processing.

The transfer control unit 72 controls the driving, transfer current, and the like of the transfer unit 28. The transfer control unit 72 controls the transfer unit 28 to transfer, to a sheet, the toner image transferred to the transfer belt 27 in accordance with an operation instruction from the printer CPU 61. The fixing control unit 73 controls driving of the fixing unit 29. The fixing control unit 73 drives the heat roller 29b and the pressurizing roller 29c in accordance with an operation instruction from the printer CPU 61. The fixing control unit 73 controls the heating unit 29a to control the surface temperature of the heat roller 29b to a fixing temperature.

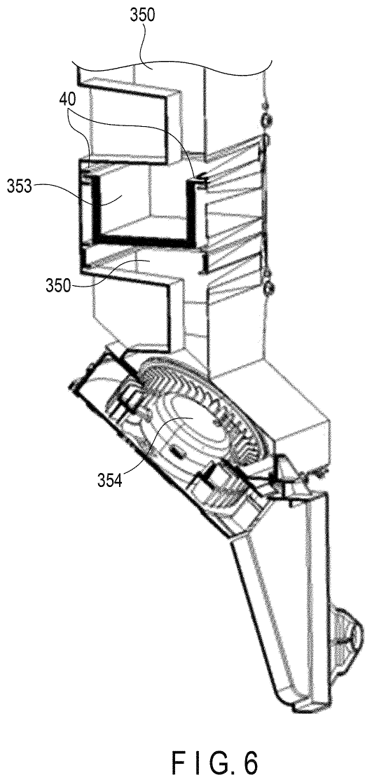

The driving control circuit 74 is a circuit that drives a fan motor 354 (see FIG. 6) in the toner suction unit 35 including the toner filter (filter) 353. The driving control circuit 74 outputs developing power for rotating the fan of the fan motor 354 to obtain a predetermined air volume.

Note that in the image forming apparatus 100, a program to be executed by the system CPU 51 or the printer CPU 61 suffices to be stored in a writable storage device. For example, a program may be written in a storage device in accordance with the operation of an administrator or the like. A program or the like may be transferred by storing it in a removable computer-readable storage medium or by communication via a network. The computer-readable storage medium can take any form as long as it can store a program and be read by an apparatus, like a CD-ROM or a memory card.

Next, the configuration of the image forming station 25 (25Y, 25M, 25C, or 25K) in the electrophotographic printer 2 of the image forming apparatus 100 will be explained in detail.

FIG. 4 is a sectional view showing a configuration example of the image forming station 25 (25Y, 25M, 25C, or 25K) in the electrophotographic printer 2 of the image forming apparatus 100.

In each image forming station 25, as shown in FIG. 4, the charging unit 31, the developing unit 32, and the cleaner 34 are arranged on the surface of the photosensitive drum 30 rotating clockwise in the circumferential direction.

The charging unit 31 includes a charging needle (charger) provided to face the surface of the photosensitive drum 30. The charging unit 31 generates a corona discharge by the charging needle, and charges the surface of the photosensitive drum 30 to a predetermined potential. In the charging unit 31, an ozone is generated to cause a corona discharge by the charging needle. The ozone generated in the charging unit 31 is processed by the ozone processing unit 36 in order to prevent degradation of the photosensitive drum 30 by the ozone.

The ozone processing unit 36 decomposes the ozone generated in the charging unit 31, and discharges it outside the housing (body) of the image forming apparatus 100. The ozone processing unit 36 delivers, into the charging unit 31, air taken from outside the body, sucks the ozone-containing air in the charging unit 31, decomposes the ozone from the sucked air, and exhausts the air. If a foreign substance such as dust deposits, the charging needle in the charging unit 31 hardly discharges. Hence, the ozone processing unit 36 removes a foreign substance such as dust from air taken from outside the body by a filter, and delivers, into the charging unit 31, the air having passed through the filter.

By rotation of the photosensitive drum 30, the surface of the photosensitive drum 30 charged to a predetermined potential by the charging unit 31 moves to an exposure position (between the charging unit 31 and the developing unit 32) where the surface is irradiated with a laser beam from the exposure unit 26. The exposure unit 26 irradiates, with a laser beam controlled in accordance with image data, the surface of the photosensitive drum 30 charged to the predetermined potential at the exposure position. An electrostatic latent image corresponding to the image data is formed on the surface of the photosensitive drum 30 that is irradiated with the laser beam from the exposure unit 26.

The developing unit 32 supplies a toner as a developing material to the surface of the photosensitive drum 30 on which the electrostatic latent image is formed by the exposure unit 26. The electrostatic latent image formed on the surface of the photosensitive drum 30 is developed as a toner image with the toner supplied from the developing unit 32. That is, the developing unit 32 supplies the developing material (toner) to the electrostatic latent image formed on the surface of the photosensitive drum 30, thereby creating a visible image (toner image) with the toner.

As shown in FIG. 4, the developing unit 32 includes the developing roller 321, mixers 322, a recovery unit 325, a recovery roller 326, and the like. In the developing unit 32, the mixer 322 stirs a toner serving as a developing material and a carrier in a developing material container. The mixer 322 supplies the carrier and the stirred toner to the surface of the developing roller 321. The developing roller 321 attracts, by magnetic force, the toner supplied from the mixer 322. The developing roller 321 rotates in a state in which it attracts (holds) the toner on its surface, thereby suppling the toner to the surface of the photosensitive drum 30 coming close to the developing roller 321 at a predetermined developing position. As a result, the electrostatic latent image formed on the photosensitive drum 30 is developed with the toner supplied from the developing roller 321.

The toner image as a visible image that is developed on the surface of the photosensitive drum 30 is transferred to the transfer belt 27 by the transfer roller 33 between the developing unit 32 and the cleaner 34. The toner image transferred to the transfer belt 27 is shifted to a sheet. The cleaner 34 is configured to clean the surface of the photosensitive drum 30 after transferring the toner image to the transfer belt 27.

In the configuration example shown in FIG. 4, the developing roller 321 draws air into the developing unit 32 when rotating in a predetermined direction. The rotation of the developing roller 321 raises the internal pressure of the developing unit 32. The developing unit 32 is highly airtight in order to prevent leakage of the toner, and a gap between the joints of components is filled with a sealant. Note that a gap (air outlet) is formed between the developing unit 32 and the photosensitive drum 30 in order to deliver the toner to the surface of the photosensitive drum 30 at a developing position.

The air outlet is formed at the upper portion (upper portion of a part at which the developing roller 321 and the photosensitive drum 30 face each other) of a part through which the surface of the developing roller 321 passes after the toner is supplied to the photosensitive drum 30. The toner departing from the developing roller 321 and the toner flying up by the carrier in the developing unit 32 are attracted toward the air outlet and scatter outside the developing unit 32. The scattering of the toner outside the developing unit 32 tends to increase as the rotational speed of the developing roller 321 increases.

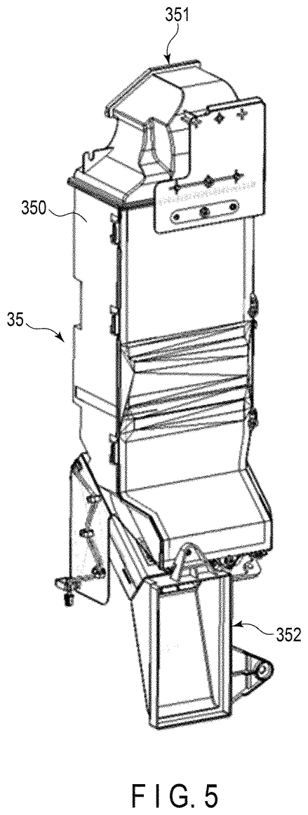

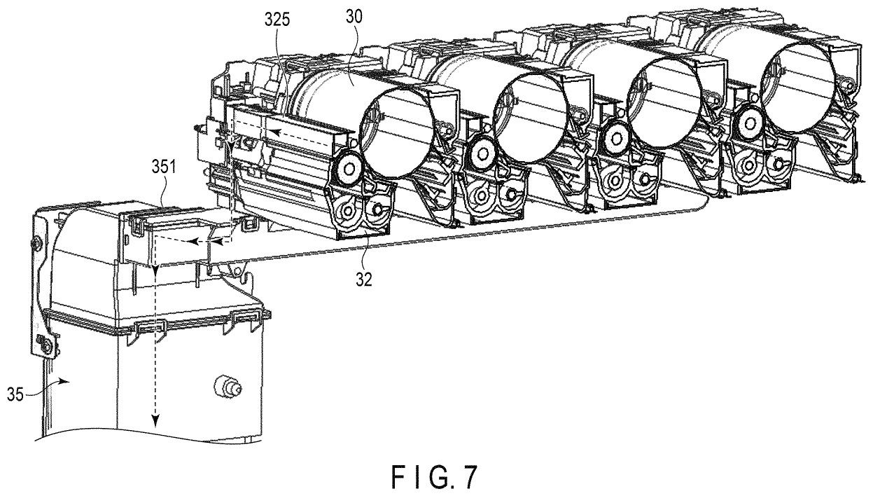

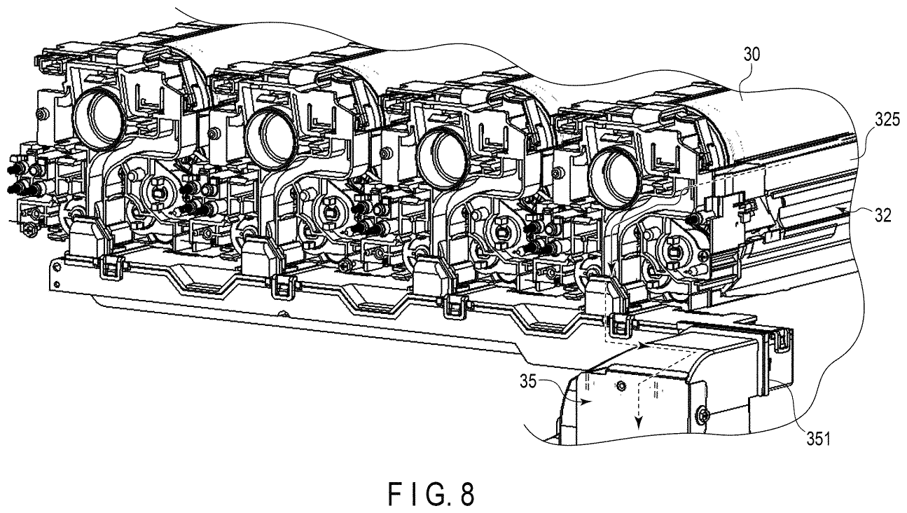

The developing unit 32 includes the recovery unit 325 for a scattering toner in order to recover a toner scattering from the air outlet. The recovery unit 325 for a scattering toner incorporates the recovery roller 326. The recovery roller 326 attracts a toner to the charged surface. The recovery unit 325 recovers the toner by scraping it from the recovery roller 326 with a blade. The recovery unit 325 is connected to the toner suction unit 35 shown in FIGS. 5 and 6 through a path as shown in FIGS. 7 and 8 (to be described later). The recovery unit 325 sends the toner recovered using the recovery roller 326 together with air to the toner suction unit 35 through the path as shown in FIGS. 7 and 8.

Next, the toner suction unit 35 in the image forming apparatus 100 according to the embodiment will be explained.

FIG. 5 is an outside view showing a configuration example of the toner suction unit 35 in the image forming apparatus 100 according to the embodiment. FIG. 6 is a sectional view showing a configuration example of the inside of the toner suction unit 35. FIGS. 7 and 8 are views showing a configuration example of a connection path between the toner suction unit 35 and the recovery unit 325 of the developing unit 32 in the image forming station 25.

As shown in FIG. 5, the toner suction unit 35 is formed by a duct 350 including an internal connection portion 351 and an external connection portion 352. In the toner suction unit 35, as shown in FIG. 6, the toner filter (pressure loss generation component) 353, a weight detector 40, and the fan motor 354 are provided in the duct 350. The toner filter 353 is installed midway along the duct 350 serving as an air (gas) path. The weight detector 40 detects the weight of a toner collected by the toner filter 353. The fan motor 354 is provided near the external connection portion 352 in the duct 350.

The fan motor 354 rotates the fan to exhaust, from the external connection portion 352, air in the duct 350 serving as the toner suction unit 35. The fan motor 354 sucks air from the internal connection portion 351 into the duct 350, and exhausts from the external connection portion 352 the air having passed through the toner filter 353 within the duct 350.

The toner filter 353 collects a toner contained in the air passing through the duct 350 of the toner suction unit 35. As shown in FIG. 6, the toner filter 353 is installed like a bag with respect to the air path in the duct 350, and stores a collected toner. The toner filter 353 is so installed as to be replaceable in maintenance.

In the configuration shown in FIG. 6, the weight detector 40 is provided in the toner filter 353. The weight detector 40 detects the weight of the toner filter 353 in a state in which a toner is collected. The weight of a toner collected by the toner filter 353 is detected by subtracting the weight of the toner filter 353 from the weight detected by the weight detector 40. The weight detector 40 detects even the weight of the toner filter 353, and thus can detect whether the toner filter 353 is set.

As shown in FIGS. 7 and 8, the internal connection portion 351 of the toner suction unit 35 is connected to the recovery unit 325 of the developing unit 32 in each image forming station 25. Air in the recovery unit 325 of each image forming station 25 is sucked by the toner suction unit 35. In FIGS. 7 and 8, arrows of solid and dotted lines indicate an air path from the recovery unit 325 of the developing unit 32 to the toner suction unit 35.

As shown in FIG. 7, the recovery unit 325 of the developing unit 32 conveys, to the back side (connection portion of the toner suction unit 35) of the image forming apparatus 100, air containing a toner scattering between the developing roller 321 and the photosensitive drum 30. As shown in FIG. 8, the air conveyed to the back side by each recovery unit 325 is collected to the duct connected to the internal connection portion 351 of the toner suction unit 35, and supplied into the toner suction unit 35.

In the toner suction unit 35 shown in FIG. 6, the toner filter 353 serving as a pressure loss generation component enhances much more the effect of hindering the passage of air as a collected toner (toner accumulated in the toner filter) increases. When the air hardly passes owing to the toner collected by the toner filter 353, the toner suction unit 35 becomes difficult to draw the toner-containing air from the recovery unit 325. If the state in which the air in the recovery unit 325 hardly flows into the toner suction unit 35 continues for a long time, the toner readily scatters within the body except the developing unit 32.

The image forming apparatus 100 is designed so that an airflow from the recovery unit 325 to the toner suction unit 35 becomes normal until a toner collected by the toner filter 353 reaches a predetermined allowance. Thus, the image forming apparatus 100 undergoes periodic maintenance so that the toner filter 353 is replaced until the toner collection amount of the toner filter 353 reaches the predetermined allowance.

For example, regular maintenance (periodic maintenance) is set for the image forming apparatus 100 in accordance with the total number (total print count) of print pages having undergone print processing by the printer 2 or the conveyance distance (driving counter). The image forming apparatus 100 is operated so that various filters including the toner filter 353 are replaced in regular maintenance by a serviceman or the like. The image forming apparatus 100 is designed so that the toner filter 353 can maintain a normal function till periodic maintenance on the assumption that the amount of toner scattering from the developing unit 32 falls within an expected range (normal range). As long as an actual toner scattering amount falls within the expected range, the toner suction unit 35 can normally recover the scattering toner by replacing the toner filter 353 in every periodic maintenance.

However, the amount of toner actually scattering from the developing unit 32 sometimes increases due to various factors. It is difficult to specify in advance the factor of a scattering toner exceeding the expected range. Hence, when a large toner scattering amount greatly exceeds the expected range, maintenance needs to be prompted before periodic maintenance in order to prevent generation of a trouble within the body.

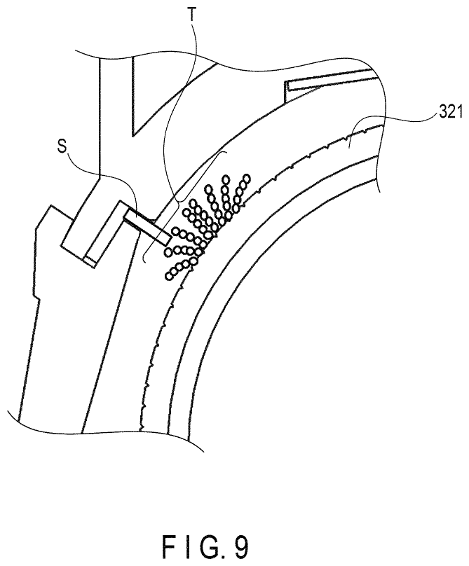

FIG. 9 is a view showing an example of a factor that increases the amount of toner scattering from the developing unit 32 to be more than an expected range.

In the developing unit 32, the developing roller 321 attracts a toner T to its surface (outer surface) by magnetic force. The developing roller 321 rotates in a state in which it attracts the toner T on the outer surface, thereby conveying the toner T to the photosensitive drum 30. The toner T on the rotating developing roller 321 is so held as to expand radially outward at a magnetic pole position, as shown in FIG. 9.

The developing container formed by combining a plurality of components is provided around the developing roller 321 so as not to discharge a toner or the like from outside the developing unit 32. The plurality of components forming the developing container of the developing unit 32 are joined tightly by a sealant. FIG. 9 shows an example in which a sealant S at the combined portion of the components in the developing unit 32 protrudes toward the developing roller 321. The sealant S does not protrude in the developing unit 32 in a normal state. The protrusion of the sealant S as shown in FIG. 9 is caused by, for example, a trouble in the manufacturing process.

As shown in FIG. 9, part of the toner T attracted to the outer surface of the rotating developing roller 321 contacts the sealant S at the portion where the sealant S protrudes. The toner T at the portion where it contacts the sealant S is physically scraped off the developing roller 321. As a result, a more-than-expected large amount of toner T is scraped off the developing roller 321 owing to the protrusion of the sealant S in the developing unit 32 shown in FIG. 9.

As described above, along with rotation of the developing roller 321, an airflow is generated in the developing unit 32 toward the air outlet (gap between the developing unit 32 and the photosensitive drum 30) at which the recovery unit 325 is provided. Most of the toner T scraped off the developing roller 321 scatters with the airflow in the developing unit 32 toward the recovery unit 325 serving as the air outlet. Therefore, the amount of toner scattering to the recovery unit 325 becomes much larger in the developing unit 32 suffering the protrusion of the sealant S as shown in FIG. 9, than in the developing unit 32 in a normal state.

When the toner scattering amount increases due to an unexpected factor as shown in FIG. 9, the amount of toner collected by the toner filter 353 exceeds the expected range. In regular maintenance (periodic maintenance), the toner filter 353 is replaced on the assumption that a toner scattering from the developing unit 32 in the normal state is recovered. When the toner scattering amount exceeds the expected range owing to an unexpected factor, the amount of toner collected by the toner filter 353 exceeds a predetermined allowance (toner full) before executing regular maintenance. If the toner filter 353 becomes full of the toner, it hardly transmits air. If the toner filter 353 hardly transmits air, the toner suction unit 35 hardly sucks the toner from the recovery unit 325 of each developing unit 32.

Next, the configuration of the weight detector 40 that detects the weight of a toner collected by the toner filter 353 in the image forming apparatus 100 according to the embodiment will be explained.

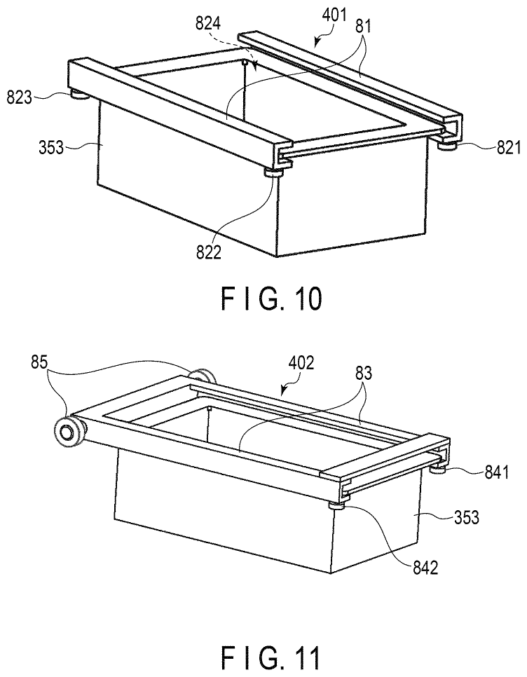

FIG. 10 is a view showing a weight detector 401 as the first configuration example of the weight detector 40 that detects the weight of a toner collected by the toner filter 353 in the image forming apparatus 100 according to the embodiment.

The weight detector 401 as the first configuration example shown in FIG. 10 includes guides 81, and sensors 82 (821, 822, 823, and 824).

The guides 81 support the toner filter 353. In the example shown in FIG. 10, the guides 81 are so provided as to support the long sides of the toner filter 353 set like a bag in the toner suction unit 35. The guides 81 may be so configured as to support the entire circumference (four sides) of the box-like toner filter 353 when viewed from the top.

A force is applied downward to the guides 81 in accordance with a force applied to the toner filter 353 in the direction of gravity (downward). That is, a downward force is applied to the guides 81 in accordance with the weight of the toner filter 353 and the weight of a toner collected by the toner filter 353.

Each sensor 82 outputs a detection signal representing a force applied downward to the guide 81. The sensor 82 is constituted by, for example, a load cell or a load cell including a piezoelectric element. The sensors 82 (821, 822, 823, and 824) are provided at four corners of the guides 81 supporting the toner filter 353. In the example shown in FIG. 10, the two sensors 821 and 824 are arranged at two ends of the guide 81 provided on one long side of the toner filter 353 set like a box, and the two sensors 822 and 823 are arranged at two ends of the guides 81 provided on the other long side.

A value obtained by adding values detected by the four sensors 82 is a value representing the weight of the toner filter 353. Weights detected by the four sensors 82 represent the total weight of the weight of the toner filter 353 and that of a toner collected by the toner filter 353. The weight of the toner collected by the toner filter 353 is calculated by subtracting the weight of the toner filter 353 from weights detected by the four sensors 82.

FIG. 11 is a view showing a weight detector 402 as the second configuration example of the weight detector 40 that detects the weight of a toner collected by the toner filter 353 in the image forming apparatus 100 according to the embodiment.

The weight detector 402 as the second configuration example shown in FIG. 11 includes guides 83, sensors 84 (841 and 842), and rotating portions 85.

The guides 83 support the toner filter 353. In the example shown in FIG. 11, the guides 83 are so provided as to support the long sides of the toner filter 353 set like a box. Each guide 83 is constituted so that one end in the long side direction in which the toner filter 353 is supported is fixed to the rotating portion 85, and the other end is movable up and down. The rotating portion 85 is constituted by a rotating shaft and a bearing, and configured so that the guide 83 moves smoothly with respect to the rotating shaft of the rotating portion 85 serving as the start point.

In the configuration example shown in FIG. 11, the sensors 84 (841 and 842) are provided at the ends of the guides 83 that move with respect to the rotating shaft of the rotating portions 85 serving as the start point. The guides 83 move with respect to the rotating shaft of the rotating portions 85 serving as the start point. In accordance with a force applied to the toner filter 353 in the direction of gravity (downward), a downward force is applied to the movable ends of the guides 83 at which the sensors 84 are provided. That is, in accordance with the weight of the toner filter 353 and the weight of a toner collected by the toner filter 353, a downward force is applied to the ends of the guides 83 at which the sensors 84 are provided.

Each sensor 84 outputs a detection signal representing a force applied downward to the movable end of the guide 83. The sensor 84 is constituted by, for example, a load cell or a load cell including a piezoelectric element. The sensors 84 (841 and 842) suffice to detect a force applied to the guides 83 in accordance with the weight of the toner filter. Thus, the number of sensors 84 provided on the guides 83 may be one, or three or more.

When the two sensors 841 and 842 are provided as shown in FIG. 11, a value obtained by adding values detected by the two sensors 841 and 842 is a value representing the weight of the toner filter 353. Weights detected by the sensors 84 represent the total weight of the weight of the toner filter 353 and that of a toner collected by the toner filter 353. The weight of the toner collected by the toner filter 353 is calculated by subtracting the weight of the toner filter 353 from weights detected by the sensors 84.

Next, state detection processing of detecting the state of the toner filter 353 by the weight detector 401 or the weight detector 402 in the image forming apparatus 100 according to the embodiment will be explained.

The image forming apparatus 100 according to the embodiment detects, by the weight detector 401 or the weight detector 402, the weight of the toner filter 353 that collects a toner. The image forming apparatus 100 determines whether a weight (or a weight change amount) detected by the weight detector 401 or 402 exceeds a predetermined threshold. In a case where the weight detected by the weight detector 401 or 402 exceeds the predetermined threshold, if the total print count (total image formation count) is smaller than a predetermined count, the image forming apparatus 100 stores, as maintenance information to be transmitted to the server apparatus 300, information representing that the toner collection amount of the toner filter 353 is abnormally large. From this, the server apparatus 300 can detect that the amount of toner collected by the filter in the image forming apparatus is abnormally large, and can provide an appropriate maintenance guide.

A sequence of state detection processing of detecting the state of the toner filter 353 by the image forming apparatus 100 according to the embodiment based on a weight detected by the weight detector 401 or 402 will be described below.

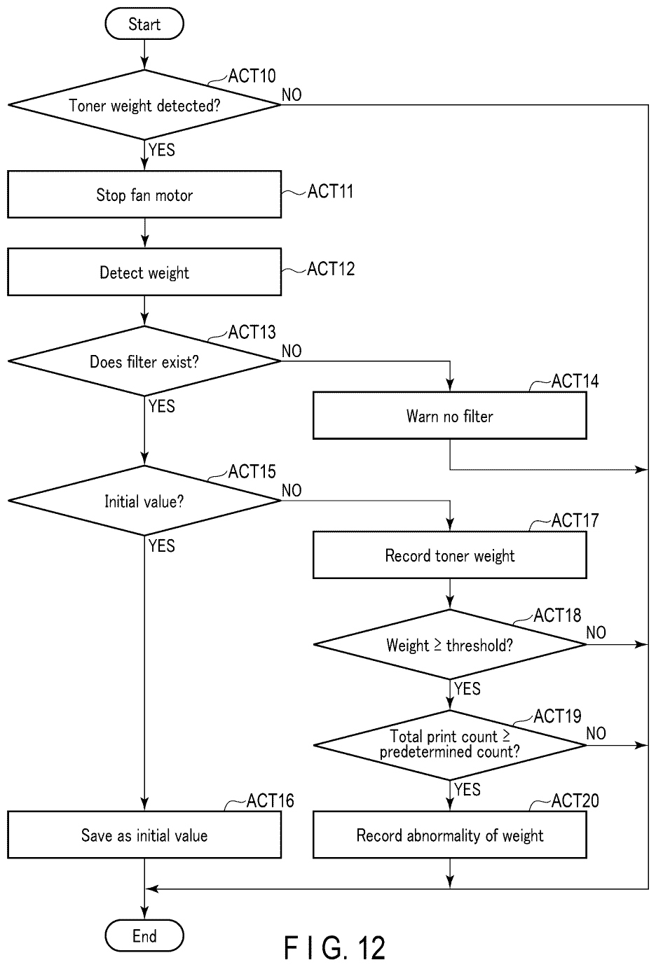

FIG. 12 is a flowchart for explaining state detection processing of detecting the state of the toner filter 353 by the image forming apparatus 100 according to the embodiment based on a weight detected by the weight detector 401 or 402.

The system CPU 51 of the image forming apparatus 100 determines whether to execute processing of detecting the weight of the toner filter 353 by the weight detector 401 or 402 (ACT10). For example, when a predetermined condition is satisfied (for example, when the total print count reaches a set count, upon completion of maintenance, or at the time of initial setup), the system CPU 51 determines to execute processing of detecting the weight of the toner filter 353. The system CPU 51 may execute weight detection by the operation panel 4 or weight detection in accordance with a toner filter state detection execution instruction.

If the system CPU 51 determines to execute weight detection of the toner filter 353 (YES in ACT10), it controls the driving control circuit 74 to stop the fan motor 354 (ACT11). Assume that the weight detector 401 or 402 detects the weight of the toner filter 353 (the weight of the toner filter and the weight of a collected toner) in a state in which the fan motor 354 is stopped. Note that the weight detector 401 or 402 may detect the weight of the toner filter 353 in a state in which the fan motor 354 is driven. In this case, the processing in ACT11 is omitted.

After the fan motor 354 is stopped, the system CPU 51 controls the weight detector 401 or 402 to detect the weight of the toner filter 353 (ACT12). The system CPU 51 obtains information representing the weight of the toner filter 353 detected by the weight detector 401 or 402.

For example, when the weight detector 40 is the weight detector 401 in the first configuration example shown in FIG. 10, the system CPU 51 obtains values detected by the four sensors 82 (821, 822, 823, and 824). The system CPU 51 uses the sum of the values detected by the four sensors 82 as a value representing the weight of the toner filter 353.

When the weight detector 40 is the weight detector 402 in the second configuration example shown in FIG. 11, the system CPU 51 obtains values detected by the two sensors 84 (841 and 842) provided at the movable ends of the guides 83. The system CPU 51 uses the sum of the values detected by the two sensors 84 as a value representing the weight of the toner filter 353.

If the weight of the toner filter 353 is detected by the weight detector 401 or 402, the system CPU 51 determines whether the toner filter 353 exists (ACT13). For example, the system CPU 51 determines whether the weight detected by the weight detector 401 or 402 is equal to or larger than a predetermined weight that should be detected as the weight of the toner filter 353. If the weight detected by the weight detector 401 or 402 is equal to or larger than the predetermined weight, the system CPU 51 determines that the toner filter 353 is set at a predetermined position. If the weight detected by the weight detector 401 or 402 is smaller than the predetermined weight, the system CPU 51 determines that the toner filter 353 is not set at a predetermined position.

If the system CPU 51 determines that the toner filter 353 does not exist (NO in ACT13), it warns that the toner filter 353 is not set at the predetermined position (ACT14). For example, the system CPU 51 displays, on the display 4a of the operation panel 4, an alert representing that the toner filter 353 is not set. Alternatively, the system CPU 51 may notify the server apparatus 300 that the toner filter 353 is not set. Note that when the system CPU 51 detects that the toner filter 353 does not exist, it may stop the printing operation until it detects that the toner filter 353 is set.

If the system CPU 51 confirms that the toner filter 353 is set (YES in ACT13), it determines whether the weight detected by the weight detector 401 or 402 is set as an initial value (ACT15). If the detected weight is set as an initial value (YES in ACT15), the system CPU 51 saves the detected weight in the NVM 54 as the initial value of the weight of the toner filter 353 detected by the weight detector 401 or 402 (ACT16).

For example, the system CPU 51 saves, as the initial value in the NVM 54, a weight detected first by the weight detector 401 or 402 after mounting a new toner filter 353. When the toner filter 353 is replaced in maintenance or the like, the system CPU 51 clears the initial value of the weight of the toner filter 353 saved in the NVM 54. In this case, the system CPU 51 saves, as the initial value in the NVM 54, a weight detected by the weight detector 401 or 402 immediately after replacing the toner filter 353.

If the detected weight is not set as an initial value (NO in ACT15), the system CPU 51 saves the weight (information representing the weight) detected by the weight detector 401 or 402 in a weight storage area ensured in the NVM 54 (ACT17). For example, the system CPU 51 saves, in the weight storage area, information representing the date and time when the weight was detected, together with the information representing the weight detected by the weight detector 401 or 402.

The system CPU 51 determines whether a weight change amount (toner weight) based on the weight detected by the weight detector 401 or 402 and the initial value is equal to or larger than a predetermined threshold (ACT18). For example, to determine whether the toner collection amount of the toner filter 353 is an allowable limit (toner full), the predetermined threshold is set in accordance with the weight of a toner amount allowed by the toner filter 353. As the determination in ACT18, the system CPU 51 may determine whether a value obtained by dividing, by a predetermined threshold, a difference between the initial value of the weight of the toner filter and the weight detected by the weight detector 401 or 402 exceeds “1”.

If the weight change amount (toner weight) based on the detected weight is smaller than the predetermined threshold (NO in ACT18), the system CPU 51 determines that the toner collection amount of the toner filter 353 is not the allowable limit. If the toner collection amount of the toner filter 353 is not the allowable limit, the system CPU 51 ends the state detection processing of the toner filter 353.

Note that when the toner collection amount of the toner filter 353 is not the allowable limit, the system CPU 51 may transmit to the server apparatus 300 information representing the detected weight. For example, the system CPU 51 may transmit, as maintenance information to the server apparatus 300, information that represents the weight of a toner collected by the toner filter 353 and is stored in the weight storage area.

If the weight change amount (toner weight) based on the detected weight is equal to or larger than the predetermined threshold (YES in ACT18), the system CPU 51 determines whether the total print count (total execution count of the printing operation) is equal to or larger than a predetermined count (ACT19). The predetermined count with respect to the total print count is a determination criterion for determining that the toner scattering amount is abnormally large.

That is, when the amount of toner scattering from the developing unit 32 along with the printing operation exceeds a normal range, the image forming apparatus 100 determines that the toner scattering amount is abnormally large. When the toner filter 353 reaches the allowable limit in a state in which the total print count is apparently small, the image forming apparatus 100 determines that the toner scattering amount is abnormally large (abnormal toner scattering amount). In other words, as long as the total print count is equivalent to periodic maintenance even in the state in which it is determined that the toner filter 353 reaches the allowable limit, the image forming apparatus 100 does not determine that the toner scattering amount is abnormal.

Based on the predetermined count serving as the determination criterion for the print count, the system CPU 51 of the image forming apparatus 100 determines whether the amount of toner scattering from the developing unit 32 along with the printing operation exceeds the normal range. The determination criterion for determining the abnormality of the toner scattering amount suffices to be a criterion for determining whether the toner scattering amount falls within the normal range. For example, the predetermined count serving as the determination criterion of the abnormality of the toner scattering amount may not be the total print count set as a condition of periodic maintenance. The predetermined count serving as the determination criterion may be set to be a value smaller than the total print count set as a condition of periodic maintenance.

If the system CPU 51 determines that the weight change amount is equal to or larger than the predetermined threshold and the total print count is smaller than the predetermined count (YES in ACT19), it stores, in a memory such as the NVM 54, information representing that the weight of the toner collected by the toner filter 353 is abnormal (ACT20). The information representing the abnormality of the toner collection amount may be a weight change amount (collected toner weight), flag information representing that the toner filter has reached the allowable limit (toner full), or the like.

The system CPU 51 stores, in a predetermined storage area of the NVM 54, the information representing the abnormality of the toner collection amount as part of information (maintenance information) representing the state of the image forming apparatus 100. The system CPU 51 transmits, to the server apparatus 300 in a predetermined transmission cycle (periodically), maintenance information including the information that represents the abnormality of the toner collection amount and is stored in the predetermined storage area of the NVM 54. When the information representing the abnormality of the toner collection amount is stored in the predetermined storage area regardless of the predetermined transmission cycle, the system CPU 51 may transmit to the server apparatus 300 the maintenance information including the information representing the abnormality of the toner collection amount.

The server apparatus 300 obtains the maintenance information from the image forming apparatus 100 via the communication interface 3003. The processor (second processor) 3001 of the server apparatus 300 stores, in a database provided in the memory 3002, the maintenance information obtained from the image forming apparatus 100. The processor 3001 determines the necessity of maintenance on the image forming apparatus 100 based on the maintenance information saved in the database. For example, when the total print count has reached the condition of periodic maintenance, the processor 3001 transmits to the serviceman terminal 400 a guide to prompt periodic maintenance of the image forming apparatus 100.

When the processor 3001 of the server apparatus 300 receives the maintenance information including the information representing the abnormality of the toner collection amount, it transmits to the serviceman terminal 400 a guide to prompt maintenance of the image forming apparatus 100 in accordance with the abnormality of the toner collection amount. For example, when the processor 3001 receives the information representing the abnormality of the toner collection amount, it transmits to the serviceman terminal 400 a guide to announce the abnormality of the toner collection amount. Further, when the processor 3001 receives the information representing the abnormality of the toner collection amount, it may transmit to the serviceman terminal 400 a guide to prompt conformation of repair, replacement, or the like of a portion (for example, the developing unit) serving as the factor of a large amount of scattering toner.

### Modification

Next, another configuration example and operation example of the weight detector 40 in the image forming apparatus 100 according to the embodiment will be explained as a modification of the above-described embodiment.

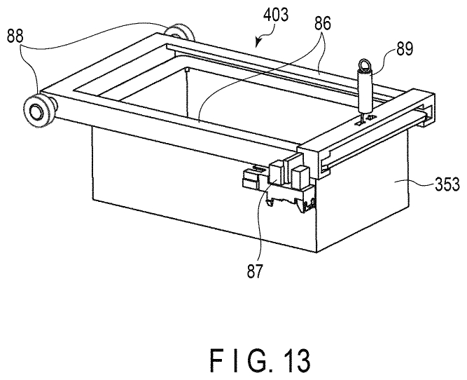

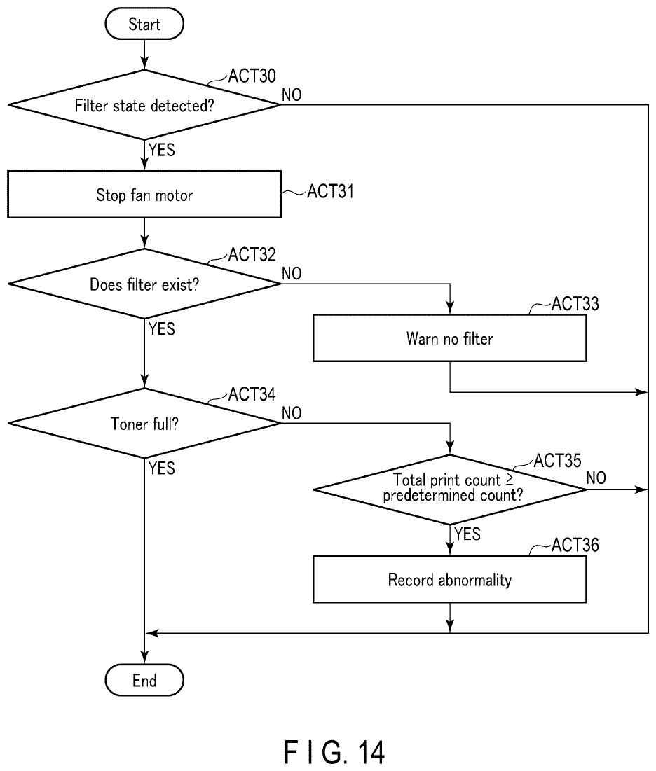

FIG. 13 is a view showing a configuration example of a detector 403 as the third configuration example of the weight detector 40 that detects the weight of a toner collected by the toner filter 353 in the image forming apparatus 100 according to the embodiment.

The detector 403 shown in FIG. 13 includes guides 86, a sensor 87, rotating portions 88, and an elastic member 89.

The guides 86 support the toner filter 353. In the example shown in FIG. 13, the guides 86 are so provided as to support the long sides of the toner filter 353 set like a box. Each guide 86 is constituted so that one end in the long side direction in which the toner filter 353 is supported is fixed to the rotating portion 88, and the other end is movable up and down. The rotating portion 88 is constituted by a rotating shaft and a bearing, and configured so that the guide 86 moves smoothly with respect to the rotating shaft of the rotating portion 88 serving as the start point.

In the configuration example shown in FIG. 13, the sensor 87 and the elastic member 89 are provided at the ends of the guides 86 that move up and down with respect to the rotating shaft of the rotating portions 88 serving as the start point. The guides 86 move with respect to the rotating shaft of the rotating portions 88 serving as the start point. In accordance with a force applied to the toner filter 353 in the direction of gravity (downward), the movable ends of the guides 86 at which the sensor 87 is provided move down.

The sensor 87 is constituted by, for example, a photosensor. The sensor 87 detects a moving amount (change amount) by which the movable end of the guide 86 moves down. The sensor 87 suffices to detect a change amount by which the movable end of the guide 86 moves down. The sensor 87 detects whether the movable end of the guide 86 has reached a predetermined measurement target value. Note that the sensor 87 may quantitatively measure a moving amount by which the movable end of the guide 86 moves down.

The elastic member 89 applies upward an elastic force in accordance with downward movement of the guide 86. The elastic member 89 is constituted by a spring or the like. The elastic member 89 has one end connected to the movable end of the guide 86, and the other end connected to a fixing portion above the movable end of the guide 86. The movable end of the guide 86 moves down to a position where a force applied downward by the weight of the toner filter 353 and an upward force of the elastic member 89 are balanced.

In the above-described detector 403, the sensor 87 is so installed as to detect that the amount of downward movement of the movable end of the guide 86 has reached a measurement target value set in advance. For example, the sensor 87 is so installed as to detect that when the toner filter 353 is full of the toner, the movable end of the guide 86 has reached a moving position (full detection position). From this, the detector 403 can detect by the sensor 87 that the toner filter 353 has reached the toner full state. The sensor 87 may include a sensor configured to detect that when a new toner filter 353 is set, the movable end of the guide 86 has reached a moving position (filter presence/absence detection position). Hence, the detector 403 can detect by the sensor 87 that the toner filter 353 is set.

Next, state detection processing of detecting the state of the toner filter 353 by the detector 403 in the image forming apparatus 100 according to the embodiment will be explained.

In the image forming apparatus 100 according to the embodiment, the detector 403 in the third configuration example detects a change amount relevant to the weight of the toner filter 353 that collects a toner. The image forming apparatus 100 determines by the detector 403 whether the amount of change corresponding to the weight of the toner filter 353 has reached a predetermined position (full detection position or filter presence/absence detection position). In a case where the detector 403 detects that the toner filter 353 is in the toner full state, if the total print count (total image formation count) is smaller than a predetermined count, the image forming apparatus 100 stores, as maintenance information to be transmitted to the server apparatus 300, information representing that the toner collection amount of the toner filter 353 is abnormally large. From this, the server apparatus 300 can detect that the amount of toner collected by the filter in the image forming apparatus 100 is abnormally large, and can provide an appropriate maintenance guide.

A sequence of state detection processing of detecting the state of the toner filter 353 by the detector 403 in the image forming apparatus 100 according to the embodiment will be described below.

FIG. 14 is a flowchart for explaining state detection processing of detecting the state of the toner filter 353 by the detector 403 in the image forming apparatus 100 according to the embodiment.

The system CPU 51 of the image forming apparatus 100 determines whether to execute processing of detecting the state of the toner filter 353 by the detector 403 (ACT30). For example, when a predetermined condition is satisfied (for example, when the total print count reaches a set count, upon completion of maintenance, or at the time of initial setup), the system CPU 51 determines to execute processing of detecting the state of the toner filter 353. The system CPU 51 may execute state detection of the toner filter 353 in accordance with a toner filter state detection execution instruction on the operation panel 4.

If the system CPU 51 determines to execute weight detection of the toner filter 353 (YES in ACT30), it controls the driving control circuit 74 to stop the fan motor 354 (ACT31). Assume that the detector 403 detects a change amount corresponding to the weight of the toner filter 353 (the weight of the toner filter and the weight of a collected toner) in a state in which the fan motor 354 is stopped. Note that the detector 403 may detect the state of the toner filter 353 in a state in which the fan motor 354 is driven. In this case, the processing in ACT31 is omitted.

After the fan motor 354 is stopped, the system CPU 51 controls the detector 403 to detect whether the toner filter 353 is set (ACT32). Based on whether the detector 403 detects that the toner filter 353 exists, the system CPU 51 determines whether the toner filter 353 is set.

If the system CPU 51 determines that the toner filter 353 does not exist (NO in ACT32), it warns that the toner filter 353 is not set at a predetermined position (ACT33). For example, the system CPU 51 displays, on the display 4a of the operation panel 4, an alert representing that the toner filter 353 is not set. Alternatively, the system CPU 51 may notify the server apparatus 300 that the toner filter 353 is not set. Note that when the system CPU 51 detects that the toner filter 353 does not exist, it may stop the printing operation until it detects that the toner filter 353 is set.

If the system CPU 51 confirms that the toner filter 353 is set (YES in ACT32), it determines whether the toner filter 353 is in the toner full state (ACT34). Based on whether the detector 403 detects that the toner filter 353 has reached the toner full state, the system CPU 51 determines whether the toner filter 353 is in the toner full state.

If the system CPU 51 determines that the toner filter 353 is not in the toner full state (NO in ACT34), it ends the state detection processing of the toner filter 353.

If the system CPU 51 determines that the toner filter 353 is in the toner full state (YES in ACT34), it determines whether the total print count (total execution count of the printing operation) is equal to or larger than a predetermined count (ACT35).

The predetermined count with respect to the total print count is a determination criterion for determining that the toner scattering amount is abnormally large. That is, when the toner filter 353 becomes full of the toner in a state in which the total print count is apparently small (lower than the predetermined print count), the image forming apparatus 100 determines that the toner scattering amount is abnormally large.

If the system CPU 51 determines that the toner filter 353 is in the toner full state and the total print count is smaller than the predetermined count (YES in ACT35), it stores, in a memory such as the NVM 54, information representing that the toner collection amount of the toner filter 353 is abnormal (ACT36). The information representing the abnormality of the toner collection amount may be, for example, flag information representing that the toner filter 353 has reached an allowable limit (toner full).

The system CPU 51 stores, in a predetermined storage area of the NVM 54, the information representing the abnormality of the toner collection amount as part of information (maintenance information) representing the state of the image forming apparatus 100. The system CPU 51 transmits, to the server apparatus 300 in a predetermined transmission cycle (periodically), maintenance information including the information that represents the abnormality of the toner collection amount and is stored in the predetermined storage area of the NVM 54. When the information representing the abnormality of the toner collection amount is stored in the predetermined storage area regardless of the predetermined transmission cycle, the system CPU 51 may transmit to the server apparatus 300 the maintenance information including the information representing the abnormality of the toner collection amount.

The server apparatus 300 obtains the maintenance information from the image forming apparatus 100 via the communication interface 3003. The processor (second processor) 3001 of the server apparatus 300 stores, in a database provided in the memory 3002, the maintenance information obtained from the image forming apparatus 100. The processor 3001 determines the necessity of maintenance on the image forming apparatus 100 based on the maintenance information saved in the database. For example, when the total print count has reached the condition of periodic maintenance, the processor 3001 transmits to the serviceman terminal 400 a guide to prompt periodic maintenance of the image forming apparatus 100.

When the processor 3001 of the server apparatus 300 receives the maintenance information including the information representing the abnormality of the toner collection amount, it transmits to the serviceman terminal 400 a guide to prompt maintenance of the image forming apparatus 100 in accordance with the abnormality of the toner collection amount. For example, when the processor 3001 receives the information representing the abnormality of the toner collection amount, it transmits to the serviceman terminal 400 a guide to announce the abnormality of the toner collection amount. Further, when the processor 3001 receives the information representing the abnormality of the toner collection amount, it may transmit to the serviceman terminal 400 a guide to prompt conformation of repair, replacement, or the like of a portion (for example, the developing unit) serving as the factor of a large amount of scattering toner.

As described above, the image forming apparatus according to the embodiment can detect the weight of the toner filter, thereby detecting that the toner collection amount of the toner filter has reached the allowable limit. When the toner collection amount has reached the allowable limit, the image forming apparatus can determine, based on the total execution count of image formation, whether the amount of toner collected by the toner filter is abnormally large. When the image forming apparatus detects that the toner collection amount is abnormally large, it can provide the server apparatus with maintenance information including the abnormality of the toner collection amount.

From this, the server apparatus can notify a serviceman that the toner collection amount becomes abnormally large in the image forming apparatus. The server apparatus can estimate that scattering of a toner from the developing unit is abnormal, and can prompt replacement of the developing unit assumed to suffer any trouble. As a result, the image forming apparatus can prevent a trouble caused by the toner scattering in the body, and reduce the time and cost of maintenance such as cleaning of the inside of the body or component replacement.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming station configured to perform image formation using a toner;
a filter configured to collect the toner scattering from the image forming station;
a sensor configured to detect a weight of the filter including the toner collected by the filter; and
a processor configured to, in a case where the weight detected by the sensor exceeds a predetermined threshold before a predetermined maintenance period comes, detect information representing an abnormality of a toner collection amount in the filter.

2. The apparatus according to claim 1, further comprising a memory configured to save a value detected as an initial value of the weight of the filter by the sensor,
wherein in a case where a weight change amount based on the weight detected by the sensor and the initial value exceeds a predetermined threshold, the processor detects the abnormality of the toner collection amount in the filter.

3. The apparatus according to claim 1, further comprising:
a duct in which the filter is provided; and
a fan motor configured to suck, into the duct, air containing the toner scattering from the image forming station,
wherein the processor detects the weight of the filter by the sensor in a state in which the fan motor is stopped.

4. The apparatus according to claim 2, further comprising:
a duct in which the filter is provided; and
a fan motor configured to suck, into the duct, air containing the toner scattering from the image forming station,
wherein the processor detects the weight of the filter by the sensor in a state in which the fan motor is stopped.

5. The apparatus according to claim 1, wherein the processor detects, based on the weight detected by the sensor, that the filter is not set at a predetermined position.

6. The apparatus according to claim 4, wherein the processor detects, based on the weight detected by the sensor, that the filter is not set at a predetermined position.

7. The apparatus according to claim 1, further comprising an external interface configured to communicate with a server apparatus,
wherein the processor transmits, to the server apparatus via the external interface, the information representing the abnormality of the toner collection amount in the filter.

8. The apparatus according to claim 1, wherein the sensor is a device configured to detect a force generated by the weight of the filter.

9. The apparatus according to claim 8, wherein the sensor is a load cell.

10. The apparatus according to claim 9, wherein the load cell includes a piezoelectric element.

11. The apparatus according to claim 1, further comprising a guide configured to support the filter, and move by a force generated by the weight of the filter,
wherein the sensor is installed at a position where the force applied to the guide is detected.

12. The apparatus according to claim 11, wherein the sensor includes a plurality of sensors that are installed at a plurality of portions of the guide, and
the processor detects a weight from a value obtained by adding values detected by the plurality of sensors.

13. The apparatus according to claim 11, wherein the guide includes one end fixed to a rotating portion, and the other end movable with respect to a rotating shaft of the rotating portion serving as a start point, and
the sensor is installed at the movable end of the guide.

14. The apparatus according to claim 13, wherein the sensor includes a plurality of sensors that are installed at a plurality of portions of the movable end of the guide.

15. The apparatus according to claim 1, further comprising a guide configured to support the filter, and move down by a force generated by the weight of the filter,
wherein the sensor is a photosensor configured to detect a moving amount by which the guide moves down.

16. The apparatus according to claim 15, further comprising an elastic member configured to apply an upward force in a case where the guide moves down.

17. The apparatus according to claim 14, wherein the guide includes one end fixed to a rotating portion, and the other end movable with respect to a rotating shaft of the rotating portion serving as a start point, and
the photosensor detects the moving amount by which the movable end of the guide moves down.

18. The apparatus according to claim 15, wherein the guide includes one end fixed to a rotating portion, and the other end movable about a rotating shaft of the rotating portion serving as a start point, and
the photosensor detects the moving amount by which the movable end of the guide moves down.

19. An image forming system comprising an image forming apparatus and a server apparatus,
the image forming apparatus including:
an external interface configured to communicate with the server apparatus;
an image forming station configured to perform image formation using a toner;
a filter configured to collect the toner scattering from the image forming station;
a sensor configured to detect a weight of the filter including the toner collected by the filter; and
a first processor configured to, in a case where the weight detected by the sensor exceeds a predetermined threshold before an image formation count reaches a predetermined count, transmit, to the server apparatus, information representing an abnormality of a toner collection amount in the filter, and
the server apparatus including:
a communication interface configured to communicate with the image forming apparatus and a serviceman terminal; and
a second processor configured to, in a case where the information representing the abnormality of the toner collection amount in the filter is obtained from the image forming apparatus via the communication interface, transmit a guide to the serviceman terminal to prompt maintenance of the image forming apparatus.

20. A non-transitory storage medium storing a program causing a processor of an image forming apparatus including an image forming station configured to perform image formation using a toner, and a filter configured to collect the toner scattering from the image forming station, to execute:
detecting, by a sensor, a value representing a weight of the filter including the toner collected by the filter;
determining whether the weight detected by the sensor has exceeded a predetermined threshold;
in a case where the weight detected by the sensor has exceeded the predetermined threshold, determining whether an image formation count of the image forming station has reached a predetermined count; and
in a case where the weight detected by the sensor has exceeded the predetermined threshold, and the image formation count of the image forming station has not reached the predetermined count yet, recording, in a memory, information representing an abnormality of a toner collection amount in the filter.
